(19) United States
(12) Patent Application Publication
(10) Pub. No.: US 2007/0201332 A1
(43) Pub. Date: Aug. 30, 2007

(54) Eccentricity Detecting Apparatus And Method

(76) Inventor: Kazuo Kuroda, Saitama (JP)

Correspondence Address: YOUNG & THOMPSON, 745 SOUTH 23RD STREET, 2ND FLOOR, ARLINGTON, VA, 22202, US

(21) Appl. No.: 10/594,535

(22) PCT Filed: Mar. 29, 2005
(86) PCT No.: PCT/JP05/05870

§ 371 Date: Nov. 22, 2006

(30) Foreign Application Priority Data
Mar. 29, 2004 (JP) 2004-094505

(51) Int. Cl. G11B 7/00

(52) U.S. Cl. 369/53.14; 369/44.32

(57) ABSTRACT

An eccentricity detecting method is a method of detecting an eccentricity between a first recording layer (L0 layer) and a second recording layer (L1 layer) of an information recording medium (100) provided with the first recording layer and the second recording layer, each of which is for recording record information, the eccentricity detecting method is provided with: a detecting process of detecting at least one of first position information indicating a position of each of at least two reference points (A, B, C, D) in one recording layer out of the first and second recording layers and second position information indicating a position of respective one of at least two target points (a, b, c, d), which corresponds to each of the at least two reference points respectively, in other recording layer out of the first and second recording layers; and a calculating process of calculating the eccentricity, on the basis of the at least one of the first and second position information detected.

### TECHNICAL FIELD

The present invention relates to an eccentricity detecting apparatus for and an eccentricity detecting method of detecting the eccentricity of an optical disc, such as a DVD, for example.

### BACKGROUND ART

For example, with regard to an information recording medium, such as a CD-ROM (Compact Disc-Read Only Memory), a CD-R (Compact Disc-Recordable) and a DVD (Digital Versatile Disk)-ROM, there has been also developed an optical disc of a multilayer type or double layer type or multiple layer type in which a plurality of recording layers are laminated on the same substrate. More specifically, a dual-layer type optical disc has a first recording layer which is on the nearest side viewed from the irradiation side of laser light in recording by an information recording apparatus (i.e. on the closest side to an optical pickup), as a first layer. The first recording layer is referred to as a “L0 layer”, as occasion demands. Moreover, it has a semi-transparent reflective film located on the rear side of the first recording layer (i.e. on the farther side viewed from the irradiation side of the laser light). The dual-layer type optical disc has a second recording layer which is located on the rear side of the semi-transparent reflective film via a middle layer, such as an adhesion layer, as a second layer. The second recording layer is referred to as a “L1 layer”, as occasion demands. Moreover, it has a reflective film located on the rear side of the second recording layer. Then, in preparing such a multilayer type information recording medium, the L0 layer and the L1 layer may be separately formed, and they are bonded together in the end, to thereby produce the dual-layer type optical disc at low cost.

In such an optical disc of a bonding type, produced by bonding the both recording layers, there are some cases where the both recording layers cannot be bonded such that their centers or the like properly correspond to each other. Namely, in some cases, an eccentricity occurs due to a shift in the central position of each recording layer. Moreover, except for this type of eccentricity, in some cases, various types of eccentricities occur, depending on the use conditions of the optical disc, the conditions of production processes or the like. Such eccentricities are not considered in an information recording/reproducing apparatus, such as a DVD recorder and a DVD player. A disc inspection is merely performed in one process of the disc production processes.

With regard to the detection of the eccentricity, performed at the time of such a disc inspection, it is performed mainly by detecting the number of tracks provided for each recording layer. Specifically, after tracking servo is opened in such a condition that a predetermined track of the first recording layer is irradiated with laser light, for example, the laser light is focused in the second recording layer, and the number of tracks crossed by the laser light is detected, to thereby detect the eccentricity (patent document 1).

Patent document 1: Japanese Patent Application Laying Open NO. Hei 11-86297

### DISCLOSURE OF INVENTION

Subject to be Solved by the Invention

However, special hardware is required for the detection of the eccentricity in such a disc inspection processes. Since this is special hardware for eccentricity detection, which is equipment mainly used for a manufacturer, the cost related to the production and use of the hardware is also high. Thus, there is such a technical problem that if the special hardware is installed on a DVD player and a DVD recorder or the like, which is equipment mainly used for consumer, the cost of the equipment for consumer greatly increases. Even if the cost can be reduced by mass production of the special hardware or the like, there is such a technical problem that there is a certain limit because the hardware is used.

In order to solve the above-mentioned conventional problems, it is therefore an object of the present invention to provide an eccentricity detecting apparatus and an eccentricity detecting apparatus method capable of inexpensively detecting the eccentricity of an information recording medium, for example, and a computer program which makes a computer function as the eccentricity detecting apparatus.

The above object of the present invention can be achieved by an eccentricity detecting method of detecting an eccentricity between a first recording layer and a second recording layer of an information recording medium provided with the first recording layer and the second recording layer, each of which is for recording record information, the eccentricity detecting method provided with: a detecting process of detecting at least one of first position information and second position information, the first position information indicating a position of each of at least two reference points in one recording layer out of the first and second recording layers, the second position information indicating a position of respective one of at least two target points, which corresponds to each of the at least two reference points respectively, in the other recording layer out of the first and second recording layers; and a calculating process of calculating the eccentricity, on the basis of the at least one of the first and second position information detected.

According to the eccentricity detecting method of the present invention, by the operation in the detecting process, at least one of the first position information and the second position information is detected. The first position information indicates the position of each of the reference points and the second position indicates the position of respective one of the target points. The target point is a point corresponding to the reference point, on the other recording layer. The expression “correspond or corresponding to” in the present invention indicates being in the same positional relationship, except for the positional relationship in the depth direction, viewed from the irradiation side of laser light, for example. It does not indicate being in such a relationship that the identity or the same of address information of the position is required. Namely, it is such a relationship that the target point is irradiated with the laser light, by changing the focal distance of the laser light irradiated onto the reference point, whereas the reference point is irradiated with the laser light, by changing the focal distance of the laser light irradiated onto the target point.

Then, by the operation in the calculating process, the eccentricity between the first recording layer and the second recording layer is detected, on the basis of at least one of the first and second position information which is detected. Namely, the eccentricity is detected, on the basis of the position relationship between the reference points on the one recording layer and the target points on the other recording layer.

By performing this eccentricity detecting method, it is possible to detect the eccentricity of the information recording medium, without requiring special hardware and a special apparatus or the like. For example, as a program for realizing the eccentricity detecting method of the present invention, it is possible to operate the program on a CPU. Thus, there is a great advantage that the eccentricity can be detected, inexpensively or at low cost. Therefore, even on general equipment mainly used for consumer, such as a DVD player, for example, it is possible to detect the eccentricity, inexpensively and properly, by performing the eccentricity detecting method of the present invention.

Consequently, according to the eccentricity detecting method of the present invention, it is possible to detect the eccentricity of the information recording medium, without using the special hardware or the like. Therefore, it is possible to detect the eccentricity, at relatively inexpensive cost.

In one aspect of the eccentricity detecting method of the present invention, the detecting process is further provided with: a laser irradiating process of irradiating each of the at least two reference points with laser light and of setting a focus position of the laser light on each of the reference points; a layer jump process of performing layer jump by which the focus position of the laser light set on each of the at least two reference points is changed to the other recording layer; and a position information detecting process of detecting the second position information by setting the focus position of the laser light on the at least two target points.

According to this aspect, it is possible to change the irradiation range of the laser light, as occasion demands, in both the reference points and the target points, by performing the layer jump and by controlling the focus position of the laser light. As a result, it is possible to detect the first position information related to the reference points and the second position information related to the target points, relatively easily and properly.

In an aspect of the eccentricity detecting method in which the detecting process includes the laser irradiating process and the like, as described above, each of the first and second recording layers has a spiral or concentric recording track, in the laser irradiating process, the focus position is set by performing tracking servo by which the focus position of the laser light is set along the recording track, in the layer jump process, the focus position is changed, with an irradiating position of the laser light fixed, in such a condition that the tracking servo is open, and in the position information detecting process, the second position information is detected in such a condition that the tracking servo is closed.

According to this aspect, it is possible to change the irradiation range of the laser light, as occasion demands, in both the reference points and the target points, by controlling the opening and closing of the tracking servo and by controlling the focus position of the laser light. As a result, it is possible to detect the first position information related to the reference points and the second position information related to the target points, relatively easily and properly.

In an aspect of the eccentricity detecting method provided with the layer jump process, as described above, a time required for the performing of the layer jump and a time required for the setting of the focus position may be equal, in each of the at least two target points.

By virtue of such construction, the time required for the performing of the layer jump from the reference point to the target point and the time required for the performing of the focusing on the target point do not vary. As a result, even if the positional relationship between the information recording medium and the laser light is changed, it is possible to preferably detect the second position coordinates of the target points corresponding to at least two reference points. Namely, it is possible to calculate the eccentricity which is more highly reliable (or highly accurate).

In another aspect of the eccentricity detecting method of the present invention, an address value capable of specifying a position on the first recording layer is recorded in advance in the first recording layer, and an address value capable of specifying a position on the second recording layer is recorded in advance in the second recording layer, and in the detecting process, address information including the address value is detected as the first and second position information.

According to this aspect, it is possible to calculate the amount of eccentricity, more properly, by detecting the address information of the information recording medium, as the position information. Moreover, it is also possible to detect the position information, relatively easily.

In an aspect of the eccentricity detecting method in which the address information is detected, as described above, the information recording medium may be a disc-shaped information recording medium, and each of the first and second recording layers may have a spiral or concentric recording track, and the first and second position information may include information indicating a radial position of the information recording medium or a track number of the recording track.

By virtue of such construction, it is possible to detect the track number based on the recording track (or the track number) provided for a general information recording medium.

In an aspect of the eccentricity detecting method in which the track number is detected, as described above, in the detecting process, at least one of the first and second position information is detected, on the basis of at least one of a first association table and a first association equation each of which associates the address information with the information indicating the radial position or the track number.

By virtue of such construction, it is possible to detect the first position information or the second position information (particularly, the track number), relatively easily, by referring to the first association table or the first association function.

In an aspect of the eccentricity detecting method in which the track number is detected, as described above, the calculating process may be provided with: a difference calculating process of obtaining a difference between the first position information and the second position information; a relationship calculating process of approximately calculating an association relationship between a position on the information recording medium and the difference, on the basis of the difference calculated in the difference calculating process; and an eccentricity calculating process of calculating the eccentricity, on the basis of the association relationship calculated in the relationship calculating process.

By virtue of such construction, it is possible to detect the eccentricity, relatively easily, on the basis of the track number of at least one of the first position information and the second position information. In particular, it is possible to represent the position on the information recording medium and the difference by using the association relationship such as an approximate curve, for example. Thus, it is possible to stably calculate the eccentricity, regardless of a difference in aspects of selecting the reference points.

In an aspect of the eccentricity detecting method in which the address information is detected, as described above, at least one of the first and second position information may include coordinate information indicating coordinates of the position on a recording surface of at least one of the first and second recording layers.

By virtue of such construction, it is possible to calculate the eccentricity, relatively easily, by using the coordinate information which is easy-to-understand to represent a position, generally.

In an aspect of the eccentricity detecting method in which the coordinate information is detected, as described above, in the detecting process, at least one of the first and second position information is detected, on the basis of at least one of a second association table and a second association equation each of which associates the address information with the coordinate information.

By virtue of such construction, it is possible to detect the coordinate information, relatively easily, by referring to the second association table and the second association function.

In an aspect of the eccentricity detecting method in which the coordinate information is detected, as described above, the calculating process is provided with: a first calculating process of calculating coordinates of a central point of the at least two target points, on the basis of the second position information; a second calculating process of calculating coordinates of a central point of the other recording layer; and an eccentricity calculating process of calculating the eccentricity, on the basis of the coordinates of the central point of the at least two target points and the coordinates of the central point of the other recording layer.

By virtue of such construction, it is possible to calculate the shift or difference between the center of the target points and the center of the other recording layer, relatively easily. As a result, it is possible to calculate the eccentricity as the shift, relatively easily.

In another aspect of the eccentricity detecting method of the present invention, the information recording medium is a disc-shaped information recording medium, and the at least two reference points are at least three reference points distributed in an area with an angle of at least 180 degrees or more on the information recording medium.

According to this aspect, it is possible to select the proper reference points. As a result, it is possible to calculate the eccentricity which is highly reliable (or highly accurate).

The above object of the present invention can be also achieved by an eccentricity detecting apparatus for detecting an eccentricity between a first recording layer and a second recording layer of an information recording medium provided with the first recording layer and the second recording layer, each of which is for recording record information, the eccentricity detecting apparatus provided with: a detecting device for detecting at least one of first position and second position information, the first position information indicating a position of each of at least two reference points in one recording layer out of the first and second recording layers, the second position information indicating a position of respective one of at least two target points, which corresponds to each of the at least two reference points respectively, in the other recording layer out of the first and second recording layers; and a calculating device for calculating the eccentricity, on the basis of the at least one of the first and second position information detected.

According to the eccentricity detecting apparatus of the present invention, as in the above-mentioned eccentricity detecting method of the present invention, it is possible to detect the eccentricity of the information recording medium, without using the special hardware or the like. Therefore, it is possible to detect the eccentricity, at relatively inexpensive cost.

These effects and other advantages of the present invention will become more apparent from the following embodiment.

As explained above, according to the eccentricity detecting method of the present invention, it is provided with: the detecting process; and the calculating process, and according to the eccentricity detecting apparatus of the present invention, it is provided with: the detecting device; and the calculating device. Therefore, it is possible to detect the eccentricity of the information recording medium, without using the special hardware or the like. Therefore, it is possible to detect the eccentricity, at relatively inexpensive cost.

### BRIEF DESCRIPTION OF DRAWINGS

FIG. 1 is a block diagram conceptually showing the basic structure of an embodiment of the eccentricity detecting apparatus of the present invention.

FIG. 2 are a plan view or a cross sectional view conceptually showing specific examples of eccentricities detected by the eccentricity detecting apparatus in the embodiment.

FIG. 3 is a flowchart conceptually showing an entire flow of a first operation example by the eccentricity detecting apparatus in the embodiment.

FIG. 4 is a plan view showing one specific example of reference points selected in the L0 layer, during the operation of the eccentricity detecting apparatus in the embodiment.

FIG. 5 is a plan view conceptually showing an operation of calculating the track number of a target point which is a layer-jump destination from the reference point, during the operation of the eccentricity detecting apparatus in the embodiment.

FIG. 6 is a graph showing an approximate curve of a difference in the track number prepared during the operation of the eccentricity detecting apparatus in the embodiment.

FIG. 7 are a graph showing a time length required for the layer jump from each reference point performed during the operation of the eccentricity detecting apparatus in the embodiment, and a plan view conceptually showing an operation of calculating the track number of the target point which is the layer-jump destination from the reference point.

FIG. 8 is a plan view showing another specific example of the reference points selected in the L0 layer, during the operation of the eccentricity detecting apparatus in the embodiment.

FIG. 9 is a flowchart conceptually showing an entire flow of a second operation example by the eccentricity detecting apparatus in the embodiment.

FIG. 10 is a plan view conceptually showing an operation of calculating the coordinates of a central point of the target points which are the layer-jump destinations from the reference points, during the operation of the eccentricity detecting apparatus in the embodiment.

FIG. 11 is a plan view showing another specific example of the reference points selected in the L0 layer, during the operation of the eccentricity detecting apparatus in the embodiment.

### DESCRIPTION OF REFERENCE CODES

100 Optical disc
300 Eccentricity detecting apparatus
351 Spindle motor
352 Optical pickup
354 CPU
355 Memory
A, B, C, D Reference point
a, b, c, d Target point

### BEST MODE FOR CARRYING OUT THE INVENTION

Hereinafter, the best mode for carrying out the present invention will be discussed in order for each embodiment, with reference to the drawings.

(Basic Structure)

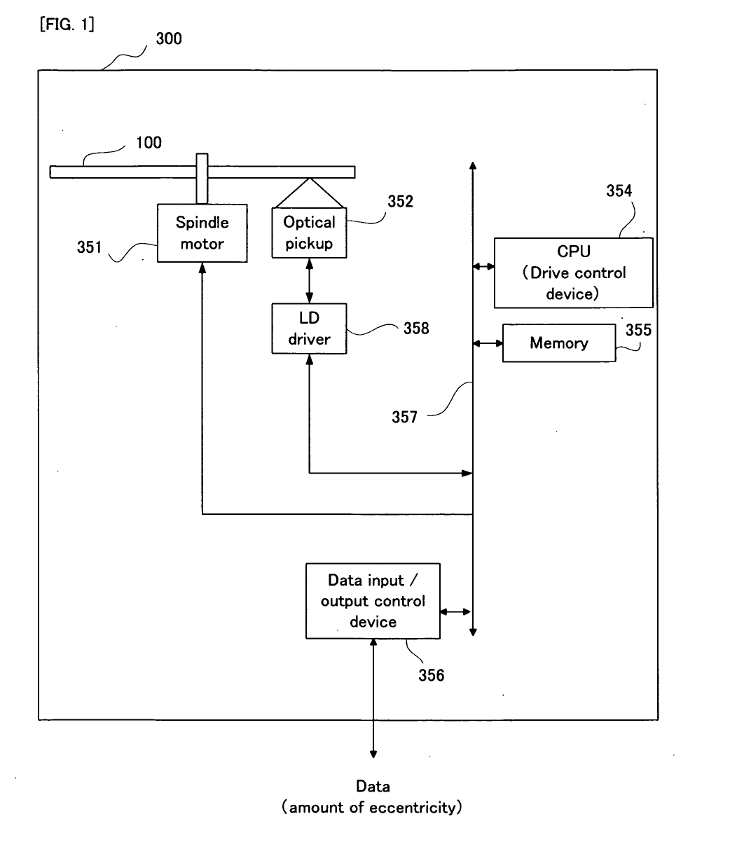

Firstly, with reference to FIG. 1, the basic structure of an embodiment of the eccentricity detecting apparatus of the present invention will be explained. FIG. 1 is a block diagram conceptually showing the basic structure of the eccentricity detecting apparatus in the embodiment.

As shown in FIG. 1, an eccentricity detecting apparatus 300 is provided with: an optical disc 100; a spindle motor 351; an optical pickup 352; a CPU (drive control device) 354; a memory 355; a Laser Diode (LD) driver 358; a data input/output control device 356; and a bus 357.

The spindle motor 351 is intended to rotate and stop the optical disc 100, and operates in accessing the optical disc 100. More specifically, the spindle motor 351 is constructed to rotate and stop the optical disc 100 at a predetermined speed under spindle servo by a not-illustrated servo unit or the like.

The optical disc 100 is a disc-shaped optical disc. As one specific example of the disc-shaped optical disc, for example, a LD (Laser Disc), a CD (Compact Disc), a DVD, a Blu-Ray Disc, an AOD (Advanced Optical Disc) or the like can be listed. Moreover, with regard to these optical discs, some discs of a different type in the format or standard (for example, various discs whose standard or format is different) such as a DVD-R and a DVD-RAM, are also included in one specific example of the optical disc 100, obviously. Then, the optical disc is mounted such that it can be rotated by the operation of the spindle motor 351, substantially with its center as a rotation center axis.

The optical pickup 352 irradiates the optical disc 100 with laser light, and is provided with a laser apparatus and a lens.

The CPU (drive control device) 354 is connected to the signal recording/reproducing device 353 and the memory 355 via the bus 357, and controls the entire operation of the eccentricity detecting apparatus 300 by giving an instruction to each control device. In general, software for operating the CPU 354 is stored in the memory 355.

Particularly in the embodiment, the amount of eccentricity of the optical disc 100 is calculated by the control of the CPU 354. This operation will be described later in detail.

The memory 355 is used in the whole data processing on the eccentricity detecting apparatus 300. Moreover, the memory 355 is provided with: a Read Only Memory (ROM) area into which a program for performing an operation as the eccentricity detecting apparatus 300; a buffer used for compression/extension (or decoding/encoding) of various data; a Random Access Memory (RAM) area into which a parameter required for the operation of a program or the like is stored; and the like.

The data input/output control device 356 is constructed to output the calculated amount of eccentricity to various external connected equipment, such as a DVD player and a DVD recorder, or to output various data required for the operation of the eccentricity detecting apparatus 300 from external input equipment.

The LD driver 358 oscillates the laser diode or the like of the optical pickup 352 at a predetermined frequency, to thereby control the laser light irradiated from the optical pickup 352.

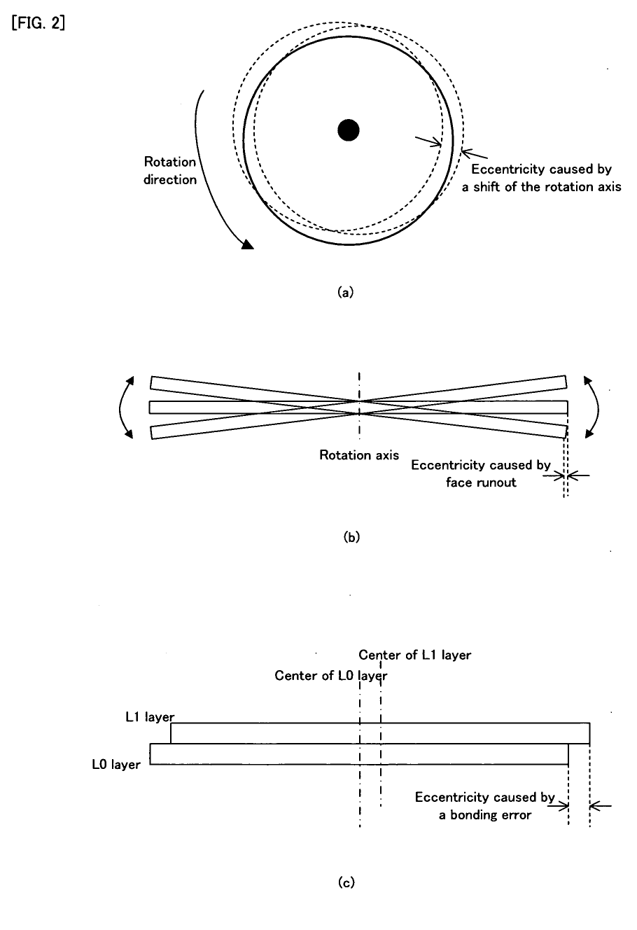

Next, the specific examples of the eccentricities which can be detected by the eccentricity detecting apparatus 300 in the embodiment will be explained, with reference to FIG. 2(a), FIG. 2(b) and FIG. 2(c). FIG. 2(a), FIG. 2(b) and FIG. 2(c) are a plan view or a cross sectional view conceptually showing specific examples of the eccentricities detected by the eccentricity detecting apparatus in the embodiment.

As shown in FIG. 2(a), if the center of the disc-shaped optical disc 100 and the rotation center axis of the optical disc 100 do not match, an eccentricity occurs due to a shift or deviation of the rotation center axis. If the optical disc shown in a thick black line in FIG. 2(a) is rotated around the rotation center axis shown by a black circle in FIG. 2(a), the optical disc 100 exists in a position shown in a dashed line, depending on time. In this case, even if trying to search for a predetermined track on the optical disc 100, on the basis of a distance from the rotation center axis, the optical pickup 352 cannot preferably search for it, due to the eccentricity caused by the shift of the center rotation axis. Namely, the laser light irradiated from the optical pickup 352, which is located at the same distance from the center rotation axis, is irradiated onto the optical disc 100 over a plurality of tracks. The number of the tracks (or the length of the tracks in the radial direction) irradiated with the laser light, corresponds to the eccentricity here.

Moreover, as shown in FIG. 2(b), an eccentricity caused by face wobbling occurs on the optical disc 100. Specifically, this eccentricity occurs due to the warping of the optical disc 100, specifically, in the outer circumferential portion. Therefore, in the case where there is the face wobbling (i.e. the surface of the optical disc 100 does not cross vertically to the center rotation axis) and in the case where there is not the face wobbling (i.e. the surface of the optical disc 100 crosses vertically to the center rotation axis), the laser light irradiated from the optical pickup 352, which is located at the same distance from the center rotation axis, is irradiated onto different tracks (or positions with different physical addresses). This difference in positions irradiated with the laser light between the case where there is the face wobbling and the case where there is not the face wobbling, corresponds to the eccentricity here.

Moreover, as shown in FIG. 2(c), an eccentricity caused by a bonding error or the like occurs, in the multilayer type optical disc. This eccentricity will be explained by taking the dual-layer type optical disc as an example. The dual-layer type optical disc is produced by bonding the first recording layer (L0 layer) and the second recording layer (L1 layer). At this time, if the center of the L0 layer and the center of the L1 layer do not match with respect to the center rotation axis, the recording positions (or recording areas) of the both recording layers, indicated by the same address (or the same track), do not match, as viewed from the optical pickup 352. This shift or difference of the recording positions which do not match, corresponds to the eccentricity here.

The eccentricity detecting apparatus 300 in the embodiment particularly detects the eccentricity which occurs between the first recording layer (L0 layer) and the second recording layer (L1 layer). Then, with regard to the eccentricity here, it is possible to calculate the amount of eccentricity of the entire optical disc 100, including not only the eccentricity caused by the bonding error shown in FIG. 2(c), but also the eccentricity caused by the shift of the center rotation axis shown in FIG. 2(a) and the eccentricity caused by the face wobbling shown in FIG. 2(b).

(Operation Principle)

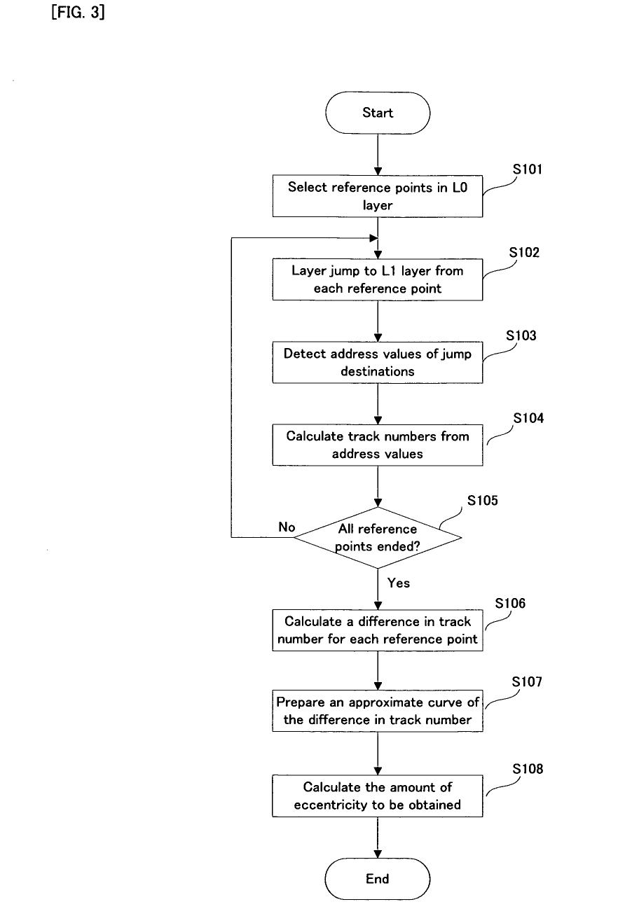

Next, with reference to FIG. 3 to FIG. 10, the operation principle of the eccentricity detecting apparatus in the embodiment will be explained.

Incidentally, in the explanation of the operation principle, the disc-shaped dual-layer type optical disc 100 is used, as one specific example of the optical disc 100. Moreover, the recording layers of the optical disc 100 are referred to as the first recording layer (L0 layer) and the second recording layer (L1 layer). The recording layer located on the closest side (or the front side) viewed from the optical pickup 352 side is referred to as the L0 layer, and the recording layer located on the farther side (or the rear side) viewed from the optical pickup 352 side is referred to as the L1 layer.

### (1) FIRST OPERATION EXAMPLE

Firstly, with reference to FIG. 3 to FIG. 8, the first operation example of the eccentricity detecting apparatus in the embodiment will be explained.

Firstly, with reference to FIG. 3, an explanation will be given for an entire flow of the first operation example out of an eccentricity detection operation. FIG. 3 is a flowchart conceptually showing the entire flow of the first operation example by the eccentricity detecting apparatus in the embodiment.

As shown in FIG. 3, after the optical disc 100, which is a target of eccentricity detection, is loaded onto the eccentricity detecting apparatus 300, reference points are selected in the L0 layer, under the control of the CPU 354 (step S101).

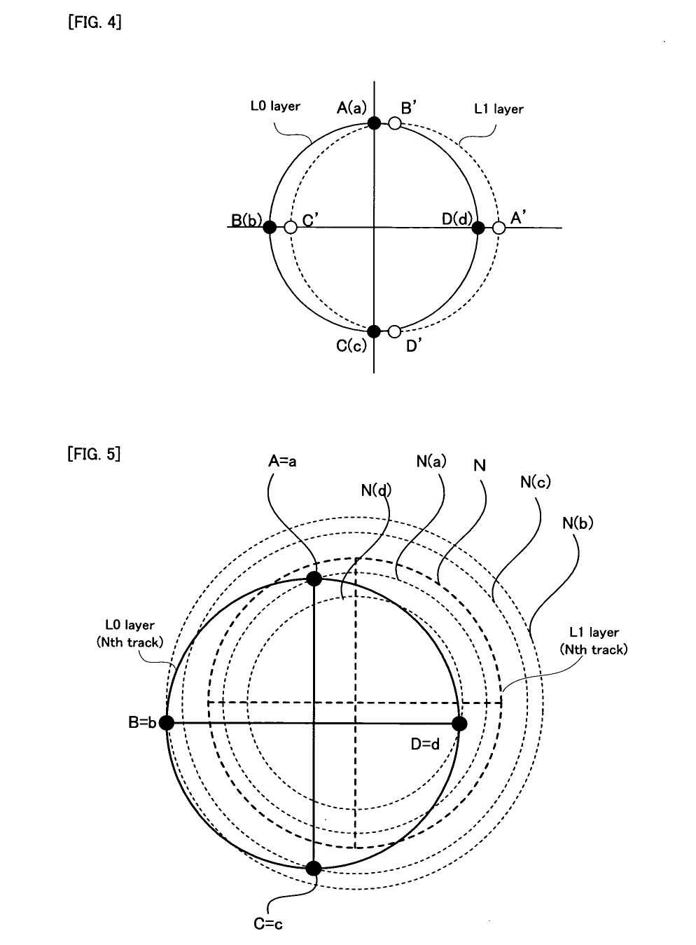

The selection of the reference points will be specifically explained, with reference to FIG. 4. FIG. 4 is a plan view showing one specific example of the reference points selected in the L0 layer.

As shown in FIG. 4, four points located on a predetermined track (N-th track) of the L0 layer may be selected. For example, a point A with a physical address of “A”, a point B with a physical address of “B”, a point C with a physical address of “C” and a point D with a physical address of “D” are selected as the reference points. At this time, the CPU 354 may select the four points on the basis of a physical address value, or from the track number or on the basis of other various information (e.g. a logical address value, a sector address value or the like).

Incidentally, the selection of the reference points may be performed automatically by the control of the CPU 354, or predetermined points on the optical disc 100 may be designated in advance by default as the reference points. Alternatively, it may be also performed on the basis of an instruction or the like of a user who uses the eccentricity detecting apparatus 300 inputted with a remote controller, a touch panel, an operation button or the like. However, as compared to the inner circumferential side of the optical disc 100, there is a larger influence by the face wobbling on the outer circumferential side. Thus, particularly in order to highly accurately detect the eccentricity caused by the bonding error, it is preferable to select the reference points on the inner circumferential side of the optical disc 100.

Then, the optical disc 100 is searched, and the physical address values or the like, recorded by an LPP (Land Pre Pit), wobble, a record mark or the like, are detected, to thereby detect points as the reference points. Then, the reference points are irradiated with the laser light, to thereby perform tracking.

Incidentally, each of the reference points preferably has an interval corresponding to an angle of approximately 90 degrees. However, as described later, it is not necessarily limited to this selection method, and other reference points may be selected. At this time, the physical address values of the reference points, the track number of the reference points or various information of the reference points may be also recorded into the memory 355 or the like.

Then, if the optical disc 100 is an optical disc of a parallel track path type, four points on the L1 layer having the same physical addresses as the physical address values of the respective four reference points, are points originally corresponding to the reference points in the case where there is no eccentricity. Specifically, a point A′ with the physical address of “A” on the L1 layer, is a point originally corresponding to the reference point A. A point B′ with the physical address of “B” on the L1 layer, is a point originally corresponding to the reference point B. A point C′ with the physical address of “C” on the L1 layer, is a point originally corresponding to the reference point C. A point D′ with the physical address of “D” on the L1 layer, is a point originally corresponding to the reference point D.

If the optical disc 100 is an optical disc of an opposite track path type, four points on the L1 layer having the physical addresses in a complement-number relationship with the physical address values of the respective four reference points, are points originally corresponding to the reference points in the case where there is no eccentricity. Specifically, a point A′ with a physical address of “InvA” on the L1 layer, is a point originally corresponding to the reference point A. A point B′ with a physical address of “InvB” on the L1 layer, is a point originally corresponding to the reference point B. A point C′ with a physical address of “InvC” on the L1 layer, is a point originally corresponding to the reference point C. A point D′ with a physical address of “InvD” on the L1 layer, is a point originally corresponding to the reference point D.

Then, as shown in FIG. 4, since there is the eccentricity on the optical disc 100, the reference point A and the point A′ whose positions are originally supposed to match (i.e. supposed to correspond), as viewed from the optical pickup 352 side, do not match.

In FIG. 3 again, the layer jump is performed to the L1 layer from each reference point (step S102). Namely, the focusing point of the laser light which has tracked each reference point (or the track on which each reference point is located), is changed from the L0 layer to the L1 layer. More specifically, tracking servo is opened, and without changing the irradiation position of the laser light, the focal distance of the laser light irradiated onto the reference point of the L0 layer, is changed to the position of the L1 layer. Then, as a result, the laser light is irradiated onto the position (i.e. target point) on the L1 layer which matches the reference point (or which is located in a position whose depth is only different), as viewed from the optical pickup 352 side. At this time, since the tracking servo is open, the laser light to irradiate does not track the track of the optical disc 100. Therefore, the laser light is irradiated onto a target point a of the reference point A. Moreover, the laser light irradiated onto the reference point B is irradiated onto a target point b on the L1 layer. The laser light irradiated onto the reference point C is irradiated onto a target point c on the L1 layer. The laser light irradiated onto the reference point D is irradiated onto a target point d on the L1 layer (refer to FIG. 4).

Then, under the control of the CPU 354, the address values (e.g. the physical address values or the like) of the target points on the L1 layer which are layer jump destinations, are detected (step S103). Here, firstly, the laser light irradiated from the optical pickup 352 is focused on the target point after the layer jump (i.e. focus-in is performed). Specifically, on the optical disc 100 shown in FIG. 4, after the layer jump to the L1 layer from the reference point A, the laser light is focused in the target point a on the L1 layer. The, by irradiating the laser light onto the LPP or the like disposed on the optical disc, for example, the physical address value of the target point a is detected as a signal component included in the reflected light of the laser light. By analyzing the signal component included in the reflected light, by the operation of the CPU 354, for example, it is possible to detect the address value of the target point. The operations of the optical pickup 352 and the CPU 354 correspond to one specific example of the operations in the “detecting process” of the present invention.

Then, the track numbers of the target points are calculated, under the control of the CPU 354, for example, on the basis of the respective address values of target points detected in the step S103 (step S104).

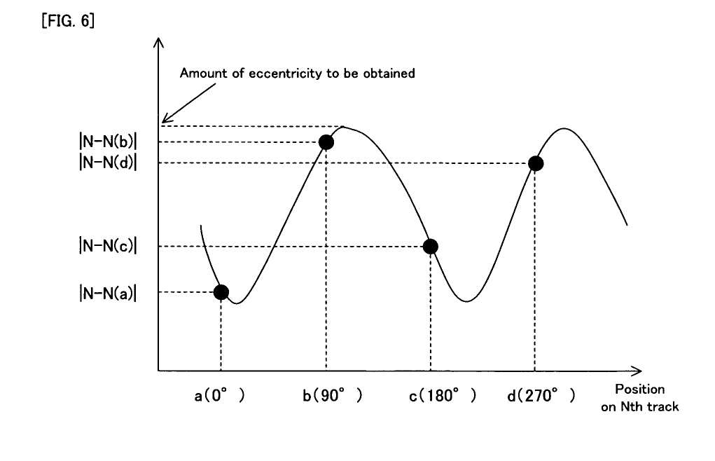

Now, the operation of calculating the track number of the target point is explained, more specifically, with reference to FIG. 5. FIG. 5 is a plan view conceptually showing the operation of calculating the track number of the target point which is the layer-jump destination from the reference point.

As shown in FIG. 5, it is assumed that the layer jump is performed from each of the reference point A, the reference point B, the reference point C and the reference point D, and that the track numbers of the target point a, the target point b, the target point c and the target point d are calculated. It is assumed that each of the reference points is located on the N-th track in the L0 layer (i.e. the track shown in a black line in FIG. 5). At this time, if there is no eccentricity, each of the target points is supposed to be located on the N-th track in the L1 layer (i.e. the track shown in a thick dashed line in FIG. 5). However, since there is the eccentricity on the optical disc 100, each of the target points is located on a different track from the N-th track (i.e. each track shown in a dashed line in FIG. 5).

In this case, as shown in FIG. 5, the target point a is located on the N(a)-th track on the L1 layer, the target point b is located on the N(b)-th track on the L1 layer, the target point c is located on the N(c)-th track on the L1 layer, and the target point d is located on the N(d)-th track on the L1 layer. At this time, the track numbers have a relationship of N(d)<N(a)<N(c)<N(b).

In the embodiment, the track numbers are calculated on the basis of the address values detected in the step S103. Thus, in the eccentricity detecting apparatus 300, a table and a function or the like for associating the track number and the address value or the like are preferably recorded in the memory 355 or the like, for example.

In FIG. 3 again, with regard to all the reference points selected in the step S101, it is judged whether or not the layer jump and the operation of detecting the address value or the like of the target point are performed. Namely, it is judged whether or not the operations are ended with regard to all the reference points (step S105).

As a result of the judgment, if it is judged that they are not ended with regard to all the reference points (the step S105: No), the operational flow returns to the step S102 again, and the operations of the step S102 to the step S104 are performed for the other reference points. Namely, in the case of the optical disc 100 shown in FIG. 4, the address value is detected and the track number is calculated, even for the target point b corresponding to the reference point B, the target point c corresponding to the reference point C and the target point d corresponding to the reference point D.

On the other hand, if it is judged that they are ended with regard to all the reference points (the step S105: Yes), a difference in the track number is calculated for each reference point, under the control of the CPU 354 (step S106). Specifically, in the case of the reference point A (i.e. the target point a), the difference in the track number is |N−N(a)|. In the case of the reference point B (i.e. the target point b), the difference in the track number is |N−N(b)|. In the case of the reference point C (i.e. the target point c), the difference in the track number is |N−N(c)|. In the case of the reference point D (i.e. the target point d), the difference in the track number is |N−N(d)|.

Then, under the control of the CPU 354, the approximate curve of the difference in the track number is prepared, on the basis of the difference in the track number calculated in the step S106 (step S107).

Now, the operation of calculating the approximate curve is specifically explained, with reference to FIG. 6. FIG. 6 is a graph showing the approximate curve of the amount of eccentricity.

As shown in FIG. 6, the approximate curve, which shows an association relationship between the difference in the track number for each reference point and the position of each reference point on the N-th track, is prepared. Specifically, firstly, the difference in the track number calculated in the step S106 is plotted on a graph, in association with the position on the N-th track. With regard to the position on the N-th track in the L0 layer, if the position of the reference point A (i.e. the target point a) is set to 0 degree, counterclockwise, the position of the reference point B (i.e. the target point b) is set to 90 degrees, the position of the reference point C (i.e. the target point c) is set to 180 degrees, and the position of the reference point D (i.e. the target point d) is set to 270 degrees. Then, the approximate curve obtained by connecting the points is prepared by using a mathematical or statistical method, such as a least square method, for example, under the control of the CPU 354. By this, the approximate curve as shown in FIG. 6 (or a function expression indicating the approximate curve) is prepared.

In FIG. 3 again, then, the amount of eccentricity to be obtained is calculated on the basis of the approximate curve prepared in the step S107 (step S108). Specifically, the difference in the track number indicating a maximum value, out of the approximate curve, is calculated as the amount of eccentricity to be obtained. Namely, the amount of eccentricity to be obtained is calculated from the number of tracks. However, the length based on the SI units may be calculated as the amount of eccentricity.

The reason to be able to calculate the amount of eccentricity in this manner is as follows. In the optical disc 100 as shown in FIG. 5, a difference in distance along the recording surface between a predetermined point on the N-th track in the L0 layer (e.g. the reference point A or the like) and a predetermined point on the N-th track in the L1 layer (e.g. the point A′ or the like), corresponds to the amount of eccentricity at maximum, and corresponds to 0 at minimum. Namely, if the maximum value of the difference in distance can be calculated, it is possible to calculate the amount of eccentricity. Therefore, the maximum value can be calculated, by extracting some points (e.g. the reference points A, B, C and D) located on the N-th track in the L0 layer and by performing an analysis by using the mathematical method or the like, on the basis of the difference in distance between these points and the N-th track in the L1 layer (e.g. the difference in the track number).

Moreover, since the tracks in each recording layer are not always uniformly distributed on each recording layer, information indicating the degree of the distribution of the tracks may be recorded in advance in the memory 355 or the like. This information may indicate that a distance between the adjacent tracks is larger on the inner circumferential side of the optical disc 100, as compared to the outer circumferential side, for example, or it may indicate the actual interval of the tracks, or the like. In this case, in accordance with the degree of the distribution of the tracks indicated by this information, it is possible to detect the amount of eccentricity, more highly accurately.

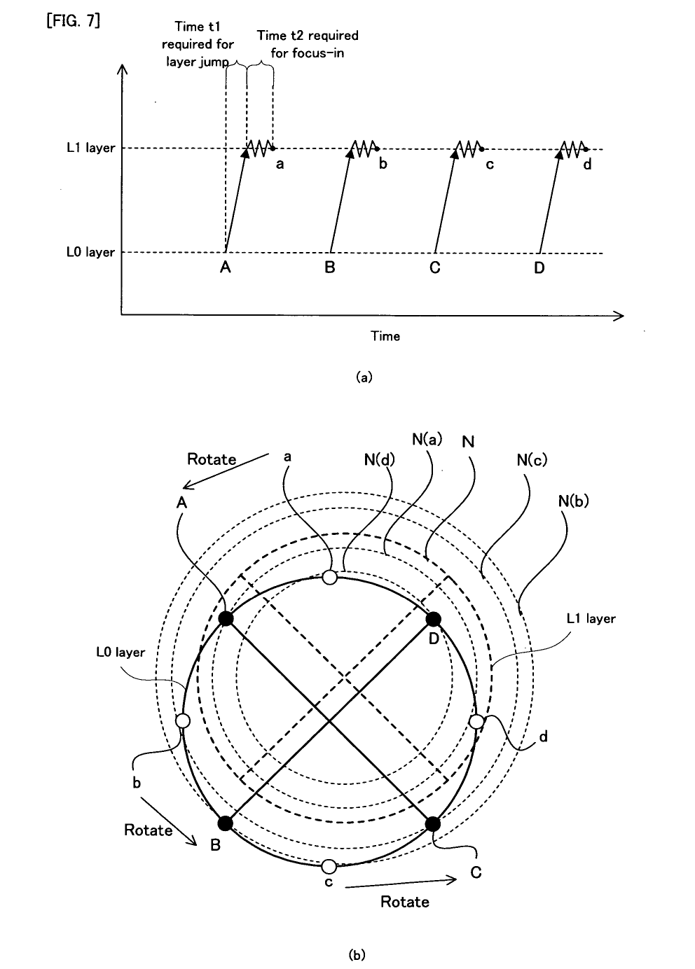

Incidentally, with regard to the layer jump in the step S102 in FIG. 3, it is explained under the assumption that there is no time lag, in the above-mentioned embodiment. However, actually, the layer jump and the focusing in the target point require a certain time length (time lag). Nevertheless, as explained later, even if there is the time lag, it is possible to properly calculate the amount of eccentricity. This operation will be explained in detail, with reference to FIG. 7. FIG. 7(a) is a graph showing the time length required for the layer jump from each reference point, and FIG. 7(b) is a plan view conceptually showing the operation of calculating the track number of the target point which is the layer-jump destination from the reference point.

As shown in FIG. 7(a), if the layer jump is performed from the L0 layer to the L1 layer (i.e. from the reference point A to the target point a), a small amount of time t1 is needed in order to change the focal distance of the laser light. Moreover, in order to focus in the target point a, a small amount of time t2 is needed in order to close the tracking servo and to set the focus of the laser light on the target point, so that it needs. This is the same for the other reference points. Then, even at this time, the optical disc 100 is rotated by the operation of the spindle motor 351, and the target point a on which the laser light is actually focused is not in a position corresponding to the reference point A (i.e. shifted), as shown in FIG. 7(b). This is because the laser light irradiated from the optical pickup 352 is not along the track of the optical disc 100 owing to the opening of the tracking servo, and as a result, the irradiation range of the laser light does not change, except in the depth direction.

However, regardless of the time t1 required for the layer jump and the time t2 required for the focus-in, it is possible to properly calculate the amount of eccentricity, as a result. The reason is as follows. Since the reference points are eventually distributed along the N-th track in the L0 layer, it can be said that the position on the L1 layer of each of the target point a, the target point b, the target point c and the target point d corresponds to an arbitrary reference point on the N-th track in the L0 layer. Thus, regardless of the length of the time required for the layer jump and the time required for the focusing in the target point, it is possible to properly calculate the amount of eccentricity.

Incidentally, if the reference points distributed at intervals of 90 degrees are selected, for example, it is possible to prepare the approximate curve which is more reliable, as compared to the case where the reference points arbitrarily distributed are selected. Therefore, from the viewpoint of detecting the amount of eccentricity which is more reliable, the time t1 required for the layer jump and the time t2 required for the focus-in are preferably common in each reference point.

For example, as shown in FIG. 7(b), it is assumed that the optical disc 100 is rotated by approximately 45 degrees while a time corresponding to t1+t2 elapses. In this case, the target point a is located near the N(d)-th track, the target point b is located near the N(c)-th track, the target point c is located near the N(b)-th track, and the target point d is located near the N(a)-th track. Then, as described above, by detecting the track number of each target point and by calculating the approximate curve, it is possible to calculate the amount of eccentricity to be obtained.

However, it is also possible to change the time t1 required for the layer jump and the time t2 required for the focus-in such that the reference point matches the target point, as viewed from the optical pickup 352 side. For example, the layer jump and the focus-in may be performed such that a time length in which the reference point A returns to the same point by the rotation of the optical disc 100 (e.g. a time length required for 1, 2, . . . , n rotations of the optical disc 100 (wherein n is a natural number)) matches the time length of t1+t2. By performing the layer jump or the like in this manner, even if the layer jump or the like requires a certain time length, it is possible to match the reference point A (B, C and D) and the target point a (b, c and d), as viewed from the optical pickup 352 side.

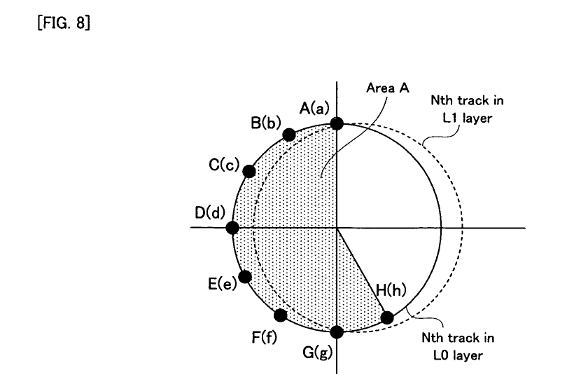

Moreover, the reference points are not necessarily uniformly selected over the entire surface of the optical disc. For example, as shown in FIG. 8, a plurality of reference points (at least four points) may be selected in an area A with an angle over at least 180 degrees. By increasing the number of the selected reference points, it is possible to increase the reliability of the approximate curve prepared in the step S107 in FIG. 3. Then, as in the above-mentioned operation example, it is possible to calculate the amount of eccentricity to be obtained, on the basis of the address values of the target points of the plurality of the reference points.

Moreover, even if three reference points are selected in an area with an angle of 180 degrees or less, it is possible to calculate the approximate curve, and as a result, it is possible to calculate the amount of eccentricity. Moreover, depending on circumstances, even in the case of two reference points, the amount of eccentricity can be properly calculated. However, in such cases, from the viewpoint of ensuring the reliability equivalent to that of the amount of eccentricity calculated in the method of selecting the four reference points, as in the above-mentioned operation example, it may be constructed such that the more proper amount of eccentricity is calculated, individually and specifically, depending on the various characteristics of the dual-layer type optical disc, represented by the production processes or the like of the optical disc, experimentally, experientially, mathematically, or theoretically, or by using simulations or the like. For example, it may be constructed to calculate a value obtained by adding or subtracting a predetermined margin calculated in the mathematical method or the like, for example, with respect to the amount of eccentricity calculated on the basis of the approximate curve, as the amount of eccentricity to be obtained. However, from the viewpoint of calculating the amount of eccentricity which is stable and highly reliable, it is preferable to select the reference points from the area with an angle over at least 180 degrees. Moreover, as the reference points, at least three or more reference points are preferably selected.

Incidentally, the amount of eccentricity to be calculated includes various aspects of the eccentricities shown in FIG. 2; however, they may be separately calculated. For example, with regard to the eccentricity shown in FIG. 2(a) and the eccentricity shown in FIG. 2(c), if the position of the rotation center axis and the central point of the recording layer are detected, it is possible to separately calculate the eccentricity caused by the shift of the rotation center axis and the eccentricity caused by the bonding error, from the calculated eccentricity. Moreover, with regard to the eccentricity shown in FIG. 2(b) and the eccentricity shown in FIG. 2(c), if the degree of the warping of the optical disc is quantitatively calculated, it is possible to separately calculate the both eccentricities.

Moreover, it is also possible to mount the eccentricity detecting apparatus 300 on a DVD recorder and a DVD player or the like, for example. In this case, the optical pickup 352 or the like can be an optical pickup provided for the DVD recorder or the like, and as a result, the eccentricity detecting apparatus 300 may be mounted on the DVD recorder or the like, in a form of the program operated on the CPU of the DVD recorder or the like. By this, it is unnecessary to use the special hardware for eccentricity detection, and it is possible to detect the eccentricity at lower cost. Moreover, on the DVD recorder or the like equipped with the eccentricity detecting apparatus 300, it is possible to more properly record the data by eliminating the adverse influence of the eccentricity, on the basis of the detected amount of eccentricity. On the DVD player or the like equipped with the eccentricity detecting apparatus 300, it is possible to more properly reproduce the data.

As explained above, according to the eccentricity detecting apparatus 300 in the embodiment, it is possible to properly calculate the amount of eccentricity of the dual-layer type optical disc or the like. In particular, the special hardware structure as in the above-mentioned background is unnecessary, and it is possible to detect the amount of eccentricity in the form of the program operated on the CPU 354. Therefore, it is possible to simplify the structure of the equipment on which eccentricity detecting apparatus 300 is mounted, and moreover, even in terms of cost, there is a great advantage that the function of “eccentricity detection” can be provided, extremely inexpensively.

### (2) SECOND OPERATION EXAMPLE

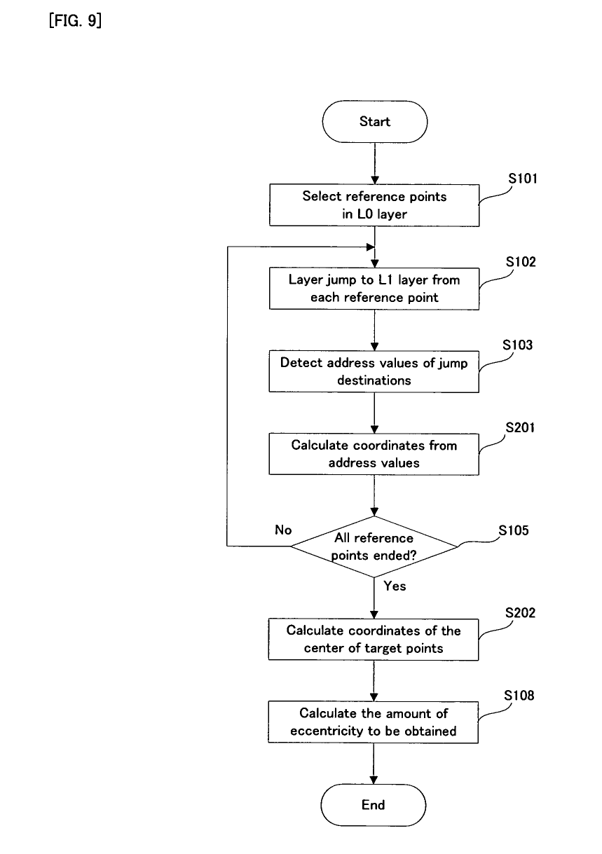

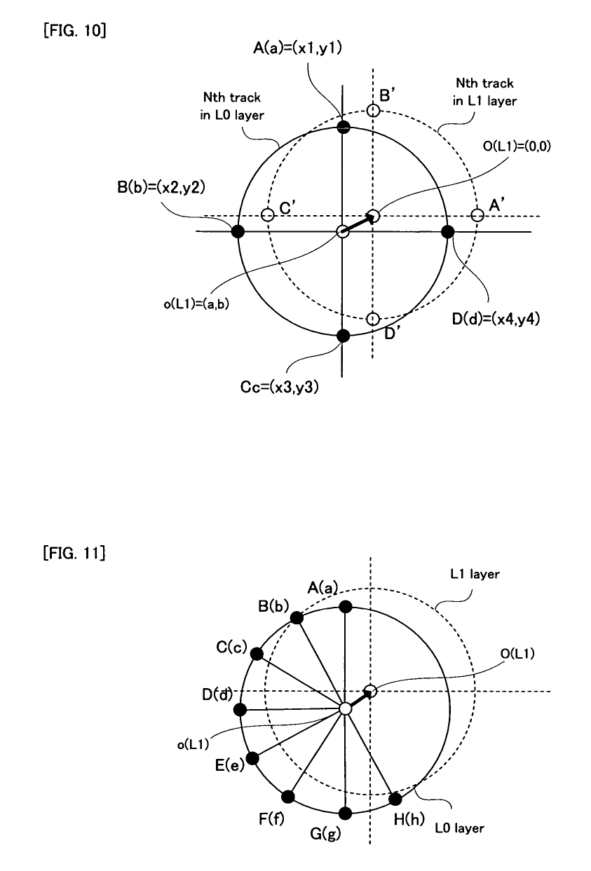

Next, with reference to FIG. 9 to FIG. 11, the second operation example of the eccentric detection operation of the eccentricity detecting apparatus in the embodiment will be explained. FIG. 9 is a flowchart conceptually showing the entire flow of the second operation example by the eccentricity detecting apparatus in the embodiment. FIG. 10 is a plan view conceptually showing the operation of calculating the coordinates of a central point of the target points which are the layer-jump destinations from the reference points. FIG. 11 is a plan view showing another specific example of the reference points selected in the L0 layer.

As shown in FIG. 9, the operations in the step S101 to the step S104 are the same as those in the first operation example. Namely, by selecting the reference points and by performing the layer jump or the like, the address value of each target point is detected.

After that, the coordinate values on the L1 layer of the target points are calculated (step S201). The coordinate values are calculated on the basis of the address values detected in the step S103. Thus, in the eccentricity detecting apparatus 300, a table and a function or the like for associating the coordinate value and the address value or the like are preferably recorded in the memory 355 or the like, for example.

Then, it is judged whether or not the operation of calculating the coordinate values with respect to each of the reference points is ended (step S105). As a result of the judgment, if it is judged that it is not ended (the step S105: No), the operational flow returns to the step S101 again. On the other hand, if it is judged that it is ended (the step S105: Yes), the operational flow goes to operations after a step S202, explained below.

Then, the coordinate value of the center of the calculated points is calculated on the basis of the coordinate values calculated in the step S201 (the step S202). This will be specifically explained with reference to FIG. 10.

As shown in FIG. 10, it is assumed that the coordinates of the target point a is calculated as (x1, y1), the coordinates of the target point b is calculated as (x2, y2), the coordinates of the target point c is calculated as (x3, y3), and the coordinates of the target point d is calculated as (x4, y4). Moreover, it is also assumed that the center of the L1 layer (i.e. a point 0 (L1)) is set to the origin point, in the coordinate axis on the L1 layer. Obviously, other points may be set to the origin point, as the coordinate axis in the L1 layer.

At this time, the equation of the circle including the reference points is expressed by (x−a)²+(y−b)²=r², wherein (a, b) is the center coordinates o (L1) and r is a radius. As a result from the equation obtained by substituting the coordinates of the target points for this equation, a value of o (L1)=(a, b) is obtained.

Then, the amount of eccentricity to be obtained is calculated on the basis of the coordinate value of the center of the target points calculated in the step S202 and the coordinate value of the center of the L1 layer (step S108). Specifically, a distance between the two centers is the amount of eccentricity to be obtained. Namely, a value expressed by an equation 1 is the amount of eccentricity to be obtained. The reason why the amount of eccentricity can be calculated in this manner is that the center of the target points is the same as the center of the reference points (i.e. the center of the L0 layer).
\sqrt{a²+b²} [Equation 1]

Moreover, even considering the presence of the time required for the layer jump and the time required for the focus-in, there is no problem in point of calculating the amount of eccentricity in the above manner. Moreover, even if the various eccentricities shown in FIG. 2 are included as the eccentricity, it is possible to calculate the amount of eccentricity of the entire optical disc 100 including the eccentricities, described in the above-mentioned explanation. However, as the eccentricity, if the eccentricity caused by the shift of the rotation center axis shown in FIG. 2(a), it is preferable to change the time t1 required for the layer jump and the time t2 required for the focus-in, as occasion demands, depending on the rotational speed of the optical disc 100, as descried above. Specifically, it is preferable to adjust (t1+t2) such that the reference point matches the target point as viewed from the optical pickup 352 side.

Moreover, as shown in FIG. 11, a plurality of reference points (at least four points) may be selected in an area A with an angle over at least 180 degrees. As in the above-mentioned operation example, it is possible to calculate the amount of eccentricity to be obtained, on the basis of the address values of the target points of the plurality of reference points. However, considering that the solution of the equation explained in the step S202 is the center of the target points and that this equation is three simultaneous quadratic equations with variables of a, b and r, it is possible to calculate the proper amount of eccentricity if at least three reference points are selected in the step S101. The three reference points may be selected in arbitrary positions of the L0 layer. However, the reference points are preferably located on the same track in the L0 layer.

As explained above, even in the second operation example, it is possible to receive the various benefits of the above-mentioned first operation example.

Moreover, in the above-mentioned embodiment, the disc-shaped optical disc 100 is explained, as one example of the information recording medium which is a target of eccentricity detection. The present invention, however, is not limited to this, and can be also applied to other information recording media including the eccentricity in a broad sense.

The present invention is not limited to the above-described embodiment, and various changes may be made, if desired, without departing from the essence or spirit of the invention which can be read from the claims and the entire specification. An eccentricity detecting apparatus, an eccentricity detecting method, and a computer program for eccentricity detection control, which involve such changes, are also intended to be within the technical scope of the present invention.

### INDUSTRIAL APPLICABILITY

The eccentricity detecting apparatus and the eccentricity detecting method of the present invention can be applied to detect the eccentricity of an optical disc, such as a DVD, for example.

1. An eccentricity detecting method of detecting an eccentricity between a first recording layer and a second recording layer of an information recording medium comprising the first recording layer and the second recording layer, each of which is for recording record information,
said eccentricity detecting method comprising:
a detecting process of detecting at least one of first position information and second position information, the first position information indicating a position of each of at least two reference points in one recording layer out of the first and second recording layers, the second position information indicating a position of respective one of at least two target points, which corresponds to each of the at least two reference points respectively, in other recording layer out of the first and second recording layers; and
a calculating process of calculating the eccentricity, on the basis of the at least one of the first and second position information detected.

2. The eccentricity detecting method according to claim 1, wherein said detecting process further comprises:
a laser irradiating process of irradiating each of the at least two reference points with laser light and of setting a focus position of the laser light on each of the reference points;
a layer jump process of performing layer jump by which the focus position of the laser light set on each of the at least two reference points is changed to the other recording layer; and
a position information detecting process of detecting the second position information by setting the focus position of the laser light on the at least two target points.

3. The eccentricity detecting method according to claim 2, wherein
each of the first and second recording layers has a spiral or concentric recording track,
in said laser irradiating process, the focus position is set by performing tracking servo by which the focus position of the laser light is set along the recording track,
in said layer jump process, the focus position is changed, with an irradiating position of the laser light fixed, in such a condition that the tracking servo is open, and
in said position information detecting process, the second position information is detected in such a condition that the tracking servo is closed.

4. The eccentricity detecting method according to claim 2, wherein a time required for the performing of the layer jump and a time required for the setting of the focus position are equal, in each of the at least two target points.

5. The eccentricity detecting method according to claim 1, wherein
an address value capable of specifying a position on the first recording layer is recorded in advance in the first recording layer, and an address value capable of specifying a position on the second recording layer is recorded in advance in the second recording layer, and
in said detecting process, address information including the address value is detected as the first and second position information.

6. The eccentricity detecting method according to claim 5, wherein
the information recording medium is a disc-shaped information recording medium, and each of the first and second recording layers has a spiral or concentric recording track, and
the first and second position information includes information indicating a radial position of the information recording medium or a track number of the recording track.

7. The eccentricity detecting method according to claim 6, wherein in said detecting process, at least one of the first and second position information is detected, on the basis of at least one of a first association table and a first association equation each of which associates the address information with the information indicating the radial position or the track number.

8. The eccentricity detecting method according to claim 6, wherein said calculating process comprises:
a difference calculating process of obtaining a difference between the first position information and the second position information;
a relationship calculating process of approximately calculating an association relationship between a position on the information recording medium and the difference, on the basis of the difference calculated in said difference calculating process; and
an eccentricity calculating process of calculating the eccentricity, on the basis of the association relationship calculated in said relationship calculating process.

9. The eccentricity detecting method according to claim 6, wherein in said detecting process, at least one of the first and second position information is detected, on the basis of at least one of a second association table and a second association equation each of which associates the address information with coordinate information indicating coordinates of the position on a recording surface of at least one of the first and second recording layers.

10. The eccentricity detecting method according to claim 9, wherein said calculating process comprises:
a first calculating process of calculating coordinates of a central point of the at least two target points, on the basis of the second position information;
a second calculating process of calculating coordinates of a central point of the other recording layer; and
an eccentricity calculating process of calculating the eccentricity, on the basis of the coordinates of the central point of the at least two target points and the coordinates of the central point of the other recording layer.

11. The eccentricity detecting method according to claim 1, wherein
the information recording medium is a disc-shaped information recording medium, and
the at least two reference points are at least three reference points distributed in an area with an angle of at least 180 degrees or more on the information recording medium.

12. An eccentricity detecting apparatus for detecting an eccentricity between a first recording layer and a second recording layer of an information recording medium comprising the first recording layer and the second recording layer, each of which is for recording record information,
said eccentricity detecting apparatus comprising:
a detecting device for detecting at least one of first position and second position information, the first position information indicating a position of each of at least two reference points in one recording layer out of the first and second recording layers, the second position information indicating a position of respective one of at least two target points, which corresponds to each of the at least two reference points respectively, in the other recording layer out of the first and second recording layers; and
a calculating device for calculating the eccentricity, on the basis of the at least one of the first and second position information detected.
